(19) United States
(12) Patent Application Publication
(10) Pub. No.: US 2017/0228151 A1
(43) Pub. Date: Aug. 10, 2017

(54) USER GESTURE FOR CONTROLLING USER OUTPUT IN CONTENT DISPLAY SYSTEM

(71) Applicant: PIKSEL, INC., Wilmington, DE (US)

(72) Inventors: Philip SHAW, York (GB); Leigh BRETT, San Marcos, CA (US); Kristan BULLETT, York (GB); Jose CARVAJAL, Malaga (ES); Felix STEKOLSHCHIK, San Diego, CA (US); Puneet JOHAR, York (GB); Hans-Jurgen MAAS, Mainz (DE); Peter HEILAND, Dover, MA (US); Ralf Wilhelm TILLMANN, Mannheim (DE); Mark CHRISTIE, Doncaster (GB)

(21) Appl. No.: 15/502,150

(22) PCT Filed: Aug. 5, 2015
(86) PCT No.: PCT/EP2015/068116

§ 371 Date: Feb. 6, 2017

Related U.S. Application Data
(60) Provisional application No. 62/033,473, filed on Aug. 5, 2014.

(51) Int. Cl. G06F 3/0488; G06F 3/14; G06F 3/16

(52) U.S. Cl. CPC G06F 3/04883; G06F 3/165; G06F 3/1454; G08C 2201/30

(57) ABSTRACT

There is disclosed a computer device having a display for displaying to a user at least one content item, wherein the display is provided on a user interface which is configured to detect a user input in the form of a swipe action over the displayed content item, wherein an audio output is responsive to the direction of swipe such that the volume of the audio output varies depending on the direction of swipe by a user.

### CROSS-REFERENCE TO RELATED APPLICATION

This application is related to, and claims priority from, “Swipe Based Volume Control”, USSN 62/033,473 (PWF Ref: 337513USP) filed on 5 Aug. 2014. The contents of that earlier application are incorporated by reference.

### BACKGROUND TO THE INVENTION

Field of the Invention

The invention relates to a device including a display providing a user interface to a user of the device, wherein the device is used to present audio content. The invention is particularly concerned with controlling the volume level of that audio content.

Description of the Related Art

In content display and delivery systems, one challenge is controlling the volume of audio delivered with visual content, such as video items.

It is an aim to provide an improved technique for controlling a volume of audio associated with visual content.

### SUMMARY OF THE INVENTION

There is provided a computer device having a display for displaying to a user at least one content item, wherein the display is provided on a user interface which is configured to detect a user input in the form of a swipe action over the displayed content item, wherein an audio output is responsive to the direction of swipe such that the volume of the audio output varies depending on the direction of swipe by a user.

The audio output may be an audio output of the computer device.

Multiple content items may be displayed simultaneously on the display, and wherein a swipe action over one content item mutes the audio of other content items which are simultaneously displayed

Multiple content items may be displayed, and a swipe action on one content item unmutes a previously muted content item, while not changing the status of other muted content items.

The content items are video assets.

The audio output of each content item may be independently controlled by a respective swipe action.

There is also provided a computer connection including a first computer device and a second computer device, wherein the audio output is provided on the second computer device.

There is further provided a method for displaying to a user at least one content item on a user interface which is configured to detect a user input in the form of a swipe action over the displayed content item, an audio output being responsive to the direction of swipe such that the volume of the audio output varies depending on the direction of swipe by a user.

The audio output may be an audio output of a computer device.

Multiple content items may be displayed simultaneously on the display, and wherein a swipe action over one content item mutes the audio of other content items which are simultaneously displayed

Multiple content items may be displayed, and a swipe action on one content item unmutes a previously muted content item, while not changing the status of other muted content items.

The audio output of each content item may be independently controlled by a respective swipe action.

A first computer device and a second computer device provided, wherein the method comprises the audio output being on provided on the second computer device.

There is provided an arrangement comprising a first computer device having a display for displaying a configurable display configuration to a user, a second computer device having a configurable display configuration mirroring the display of the first computer device, wherein a processor is configured to adjust the display of the first computer device and consequently the display of the second computer device, and terminate the mirroring of the displays such that the display of the second device is configured by configuration of the display of the first device.

The first computer device may be a handheld device. The second computer device may be a television.

There is also provided a method comprising establishing a connection between a first computer device having a display for displaying a configurable display configuration to a user and a second computer device having a configurable display configuration mirroring the display of the first computer device, adjusting the display of the first computer device and consequently the display of the second computer device, and terminating the mirroring of the displays such that the display of the second device is configured by configuration of the display of the first device.

In an example, there is provided a computer device having a display for displaying to a user at least one content item; an audio output for generating an audio signal associated with the content item; wherein the display is provided on a user interface which is configured to detect a user input in the form of a swipe action over the displayed content item, wherein the audio output is responsive to the direction of swipe such that the volume of the audio varies depending on the direction of swipe by a user.

### BRIEF DESCRIPTION OF THE FIGURES

For a better understanding of the present invention and to show how the same may be carried into effect, reference will now be made, by way of example only, to the accompanying drawings, in which:

FIG. 1 is a schematic block diagram of a user device;

FIG. 2 is a schematic diagram illustrating a swipe gesture; and

FIG. 3 is a schematic block diagram of two interacting devices.

### DESCRIPTION OF THE PREFERRED EMBODIMENT

The invention is described by way of reference to examples, and is not limited to the detail of any example. In particular the invention is described with reference to an example content delivery system.

Controlling the audio of concurrently playing videos displayed within a tile view is provided. A swiping motion up/down across the face of any tile controls the audio volume. This allows a user to view one item while listening to another, which is particularly useful if viewing content on a television while browsing on another device. Also where content has audio deemed to not be desirable, e.g. sports commentary, etc.

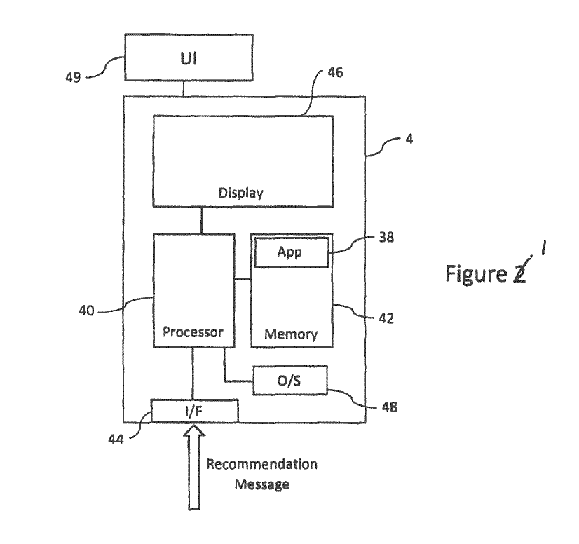

FIG. 1 is a schematic block diagram of a user terminal 4. The user terminal 4 comprises a processor 40 and a memory 42. The client application 38 is stored in the memory 42 and is executed by the processor 40. The user terminal 4 also has an interface 44 and a display 46. The display is controlled by the processor 40.

Instructions received from a server in a recommendation message by the interface 44 are used by the processor 40 to control the display 46. Although one processor is shown, it will be evident that the display could in fact be controlled by a dedicated graphics card or dedicated driver responsive to the instructions received from the server.

The user terminal 4 has its own operating system 48. When delivering content of different types to a display 46 of a known computer device, such as a smartphone or tablet, it is the operating system which is generally responsible for aggregating different types of content and driving the display to display those different types of content.

In an exemplary system however it is the client application 38 which is executed by the processor 40 and which is responsive to instructions in the recommendation message from the server which controls the display and allows the display to show different types of assets.

Thus, the application can be delivered to different kinds of devices running different kinds of operating systems (for example, android, IOS, etc.). A similar experience can be delivered to users even if they are using different device types.

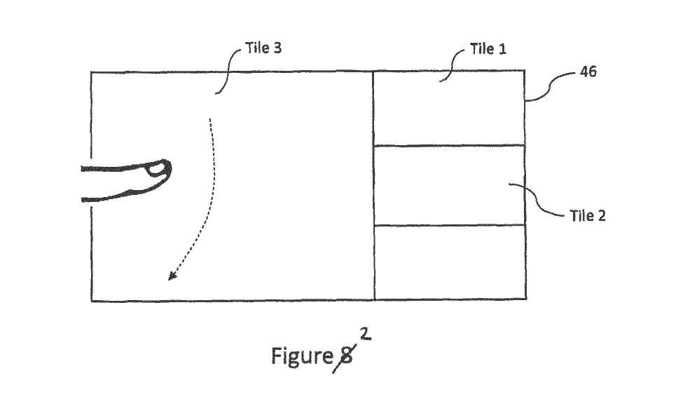

Reference will now be made to FIG. 2 to show a technique of volume control in an exemplary tile-based display.

FIG. 2 shows a display 46 of a user device. The user device has audio output means, such as a loudspeaker, which is not shown in the Figure but can be of any known type. Four tiles are shown in FIG. 2: Tile 1, Tile 2, etc. each displaying an asset. At least one of these tiles is displaying an asset with volume, in this case, Tile 3. A user can control the volume of an asset by swiping using their finger as shown in the diagram by the dotted arrow. In the embodiment, a downward swipe denotes that the volume of the audio signal generated related to that tile should be reduced and possibly muted. Alternatively, an upward swipe could indicate that the volume of that tile should be increased and simultaneously other tiles muted.

Each asset can have its volume independently Adjusted—there may be multiple audio output streams running simultaneously.

There is thus described a computer device having a display for displaying to a user at least one content item; an audio output for generating an audio signal associated with the content item; wherein the display is provided on a user interface which is configured to detect a user input in the form of a swipe action over the displayed content item, wherein the audio output is responsive to the direction of swipe such that the volume of the audio varies depending on the direction of swipe by a user.

Multiple content items may be displayed simultaneously on the display, wherein a swipe action over one content item mutes the audio of other content items which are simultaneously displayed.

Multiple content items may be displayed, and a swipe action on one content item unmutes a previously muted content item, while not changing the status of other muted content items.

Content items may be video assets.

In this example the technique is used on a computer device to control an audio output associated with the computer device itself. However the invention may also be used to control the audio output of a second computer device. In such an example the computer device is the first device, and it is connected to the second device.

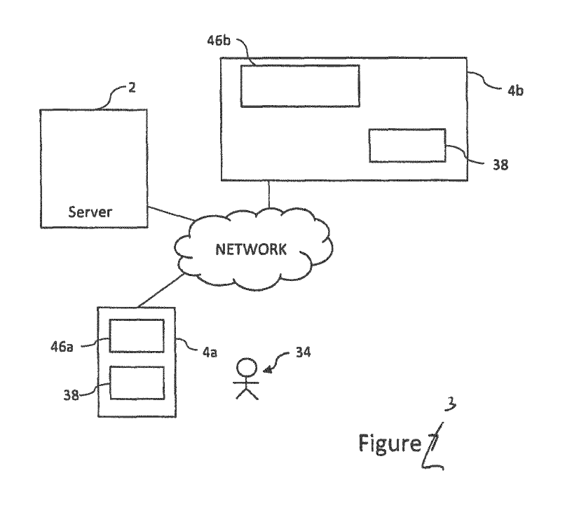

Reference will now be made to FIG. 3 to describe use of the configurability of the display on the user device 4 to allow the user device 4a to control another device.

FIG. 3 illustrates a first user device 4a (which can be referred to as a companion device) which can for example be a tablet or smartphone, or in any event something with a relatively small display as compared with a second device 4b. The second device 4b can be for example a TV or other large screen device, for example, driven from or incorporating a set-top box.

Both devices run a consumer application 38. A network is shown by which the devices can communicate. It will readily be appreciated that the network is a schematic illustration of any form of communication system allowing the devices to communicate.

A server 2 is also shown connected to the network. The server 2 may be a content delivery server.

In the illustrated configuration, the companion device 4a can be controlled by a user in the following way.

A set of assets may be on display at the companion device 4a. A particular display or tile format is presented to a user. This format can be mirrored on the display 46b of the second device 4b. Thus, a user can now see on the companion device and the larger device the same display format.

The user can configure the format to their taste on the companion device by suitable user input (for example, with a touch screen the user can change the size of tiles by gesture, or drag tiles to different locations).

Once the user is satisfied with the new configuration, this can be uploaded to the second device 4b so that the new configuration is shown on the screen 46b. Then, the companion device can be reset into an independent mode whereby it can continue to recommend asset and content using its default display configuration, or another configuration selected by the user.

The other device 4b will no longer follow the configuration once the user device 4a has been put back into an independent mode.

The invention has been described by way of reference to various examples to help in understanding. The invention is not limited to the detail of any example unless such detail is presented as essential by inclusion in an independent claim. All details of all embodiments may be combined either selectively or as a whole, and the invention does not exclude any combination nor is the invention limited to any combination unless such combination is presented as essential by inclusion in an independent claim.

The invention may be implemented in an apparatus, a method, or computer program code.

The apparatus may be a user device, or a server to which a user device is connected, or a system comprising a user device and a server. Each apparatus may include, at least, a processor and a memory and generally be implemented in a user device, or a server to which a user device is connected, or both a user device and a server.

The method may be a computer program. A computer program may be a computer program or executable code which, when run or executed on an apparatus, performs the method. The computer program or executable code may be run on the user device, or the server, or both the user device and the server.

The computer program may be stored on a memory, and may be stored across multiple memories. The memory may be a memory of a functional device, or may be a specific memory storage apparatus such as a memory disk or memory stick. The memory may be a memory available on a network, such as a memory area available in a network such as an area of a so-called ‘cloud’.

Aspects of the inventions described herein include any or all of the following features used in any combination. In addition, methods, and computer programs for implementing the method, are contemplated.

The invention has been described with reference to particular examples, and is not limited to the specifics of any example unless it is defined as essential in the appended claims.

1. A computer device having a display for displaying to a user multiple content items, wherein the display is provided on a user interface which is configured to detect a user input in the form of a swipe action over one of the displayed multiple content items, wherein an audio output is responsive to a direction of swipe such that a volume of the audio output varies depending on the direction of swipe by the user, wherein multiple content items are displayed simultaneously on the display, and wherein a swipe action over one of the multiple displayed content items varies the volume of the audio output associated with that content item and modifies the audio output associated with the other content items.

2. A computer device according to claim 1 wherein the audio output is an audio output of the computer device.

3. (canceled)

4. A computer device according to claim 1 wherein a swipe action on one content item unmutes a previously muted content item, while not changing the status of other muted content items.

5. A computer device according to claim 2 wherein the content items are video assets.

6. A computer device according to claim 2 wherein the audio output of each content item is independently controlled by a respective swipe action.

7. A computer device according to claim 1 connected to a second computer device, wherein the audio output is provided on the second computer device.

8. A method for simultaneously displaying to a user multiple content items on a user interface which is configured to detect a user input in the form of a swipe action over one of the multiple displayed content items, an audio output being responsive to a direction of swipe such that a volume of the audio output varies depending on the direction of swipe by the user, further comprising, responsive to detecting a swipe action over one of the multiple displayed content items, varying the volume of the audio output associated with that content item and modifying the audio output associated with other content items.

9. The method according to claim 8 wherein the audio output is an audio output of a computer device.

10. (canceled)

11. The method according to claim 9, wherein a swipe action on one content item unmutes a previously muted content item, while not changing the status of other muted content items.

12. A method according to claim 9, wherein the audio output of each content item is independently controlled by a respective swipe action.

13. A method according to claim 8, further comprising: connecting a second computer device, wherein the audio output is provided on the second computer device.

14. An arrangement comprising a first computer device having a display for displaying a configurable display configuration to a user, a second computer device having a configurable display configuration mirroring the display of the first computer device, wherein a processor is configured to adjust the display of the first computer device to a first configuration, and consequently adjust the display of the second computer device to the first configuration, and terminate the mirroring of the displays such that the display of the first device can be configured independently of the configuration of the display of the second device and further changes to the configuration of the display of the first computer device do not affect the configuration of the display of the second computer device

15. The arrangement of claim 14 wherein the first computer device is a handheld device.

16. The arrangement of claim 14 wherein the second computer device is a television.

17.-19. (canceled)

20. A computer devise according to claim 1 wherein a swipe action on one content item unmutes a previously muted content item, while muting other content items.

21. A method according to claim 8 wherein a swipe action on one content item unmutes a previously muted content item, while muting other content items.
